(19) United States
(12) Patent Application Publication
(10) Pub. No.: US 2007/0103620 A1
(43) Pub. Date: May 10, 2007

(54) Color filter and liquid crystal display using same

(75) Inventors: Charles Leu, Fremont, CA (US); Tai-Cherng Yu, Tu-Cheng (TW); Jhy-Chain Lin, Tu-Cheng (TW); Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/416,747

(22) Filed: May 3, 2006

(30) Foreign Application Priority Data
Nov. 4, 2005 (TW) 94138825

(51) Int. Cl. G02F 1/1335

(52) U.S. Cl. 349/106

(57) ABSTRACT

A color filter is provided. The color filter includes: a base; a black matrix arranged on the base; a grating layer arranged on the base, the grating layer comprising a plurality of grating units separated by the black matrix, the grating units being comprised of a piezoelectric material, the grating unit comprises a plurality of striated microstructures; and a controlling circuit comprising a plurality of controlling units electrically connected with the respective striated microstructures, the controlling units each being configured to apply a voltage to their corresponding striated microstructures so as to adjust a grating constant associated therewith, thereby allowing light with a predetermined wavelength to be filtered through the grating unit.

### BACKGROUND

1. Technical Field

The present invention relates to color filters, and more particularly, to a color filter having a piezoelectric material and a liquid crystal display using the color filter.

2. Discussion of Related Art

A color filter is one of the most important elements in a liquid crystal display. The color filter is generally used in the liquid crystal display for converting white light beams transmitted therethrough into red light beams, green light beams and blue light beams. The red light beams, the green light beams and the blue light beams are configured to display color images.

Referring to FIG. 6, a typical color filter 1 generally includes a substrate 10, a black matrix layer 12, a color layer, and an indium-tin oxide (ITO) layer 11. The black matrix layer 12 is formed on the substrate 10 and is used to separate sub-pixels of the color layer from each other. The sub-pixels of the color layer are red pigment 13, green pigment 14 and blue pigment 15. The ITO layer 11 is formed on the color layer. When the white light beams transmitting through the color layer are converted into red light beams, green light beams and blue light beams, the red pigment 13, the green pigment 14 and the blue pigment 15 decrease the brightness of the red light beams, the green light beams and the blue light beams and consequently decrease the brightness of the liquid crystal display.

In addition, when the red pigment 13, the green pigment 14 and the blue pigment 15 are deposited on the substrate 10 using conventional methods the pigments may overlap creating an overlap area 16. The overlap area 16 can influence uniformity and brightness of light passing therethrough, and the display quality of the liquid crystal display will consequently be influenced.

What is needed, therefore, is a color filter and a liquid crystal display with enhanced uniformity and brightness.

### SUMMARY

In one embodiment, a color filter includes a grating including: a base; a black matrix arranged on the base; a grating layer arranged on the base. The grating layer comprising a plurality of grating units separated by the black matrix, the grating units being comprised of a piezoelectric material, the grating unit comprising a plurality of striated (i.e. long parallel lines) microstructures; and a controlling circuit comprising a plurality of controlling units each electrically connected with its respective striated microstructures. Each of the controlling units being configured to apply a voltage to its respective striated microstructure so as to adjust the grating constant associated therewith, thereby allowing light with a predetermined wavelength to be filtered through the grating unit.

In another embodiment, a liquid crystal display includes a liquid crystal display panel; a backlight module; a color filter disposed between the liquid crystal display panel and the backlight module, the color filter comprising a base; a black matrix arranged on the base; a grating layer arranged on the base, the grating layer comprising a plurality of grating units separated by the black matrix, the grating units being comprised of a piezoelectric material. The grating unit comprises a plurality of striated microstructures; and a controlling circuit comprising a plurality of controlling units electrically connected with the respective striated microstructures, with each controlling unit being configured to apply a voltage to its corresponding striated microstructure so as to adjust the grating constant associated therewith. Thus allowing light with a predetermined wavelength to be filtered through the grating unit.

Other advantages and novel features of the present color filter will become more apparent from the following detailed description of preferred embodiments when taken in conjunction with the accompanying drawings.

### BRIEF DESCRIPTION OF THE DRAWINGS

Many aspects of the present color filter and related liquid crystal display can be better understood with reference to the following drawings. The components in the drawings are not necessarily drawn to scale, the emphasis instead being placed upon clearly illustrating the principles of the present color filter and related liquid crystal display.

FIG. 1 is a schematic, perspective view of a color filter in accordance with a first embodiment;

FIG. 2 is a partly, plan view of the color filter of FIG. 1, showing a cross-sectional profile of an arcuate striated microstructure of the color filter;

FIG. 3 is a partly, plan view of the color filter of FIG. 1, showing that a cross-sectional profile of a striated microstructure of the color filter is a trapezoid;

FIG. 4 is a schematic, plan view of a liquid crystal display in accordance with a second embodiment;

FIG. 5 is a schematic, plan view of a liquid crystal display in accordance with a third embodiment; and

FIG. 6 is a schematic, cross-sectional view of a conventional color filter.

Corresponding reference characters indicate corresponding parts throughout the drawing. The exemplifications set out herein illustrate at least one preferred embodiment of the present invention, in one form, and such exemplifications are not to be construed as limiting the scope of the invention in any manner.

### DETAILED DESCRIPTION OF PREFERRED EMBODIMENTS

Reference will now be made to the drawings to describe embodiments of the present color filter and liquid crystal display.

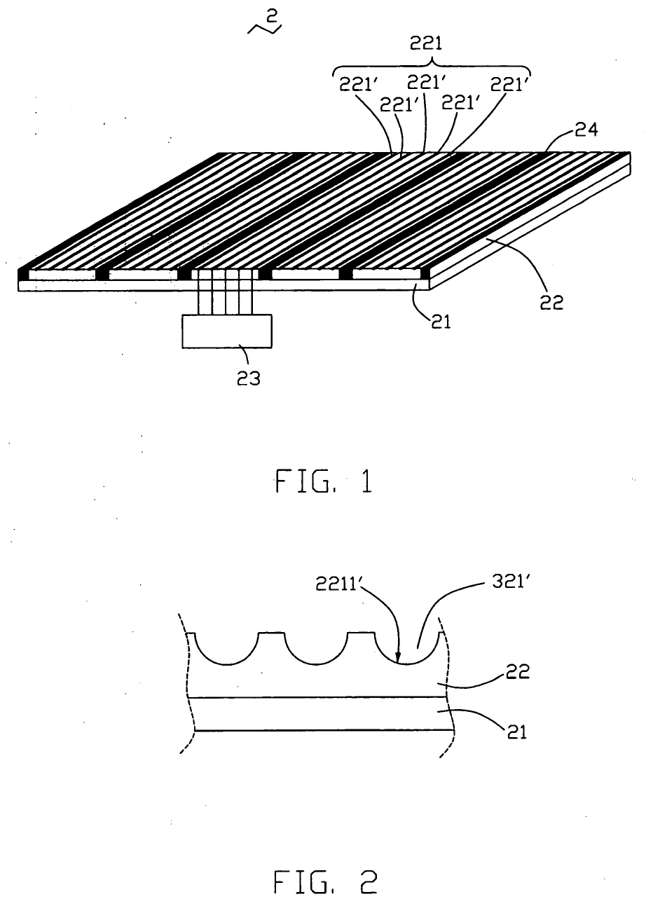

Referring to FIG. 1, a color filter 2 in accordance with a first embodiment of the present invention is shown. The color filter 2 includes a base 21 and a grating layer 22 formed on the base 21. The grating layer 22 includes a plurality of grating units 221 being comprised of a piezoelectric material. Each grating unit 221 may be a phase grating. Each grating unit 221 includes a plurality of striated microstructures 221′. A control circuit 23 includes a plurality of controlling units where each controlling unit is electrically connected to its respective striated microstructure 221′. It is recognized that if a piezoelectric material is subjected to a voltage differential, it mechanically deforms. The controlling units are configured to apply a voltage to the respective striated microstructure 221′ so as to adjust a grating constant associated with the corresponding grating unit, thereby allowing light with a predetermined wavelength to be filtered through the grating unit. A black matrix 24 is arranged on the base 21, and is used for separating the grating units 221 from each other.

The base 21 is made from a transparent material such as an insulated glass. Preferably, the grating layer 22 is comprised of a piezoelectric material, such as plumbozirconium titania (PZT), lithium niobate (LiNbO.sub.3), lithium tantalate (LiTaO.sub.3), and zinc oxide (ZnO). A base film such as polyvinyl chloride (PVC) can be optionally arranged between the grating layer 22 and the base 21. The base film is used for connecting grating layer 22 and the base 21.

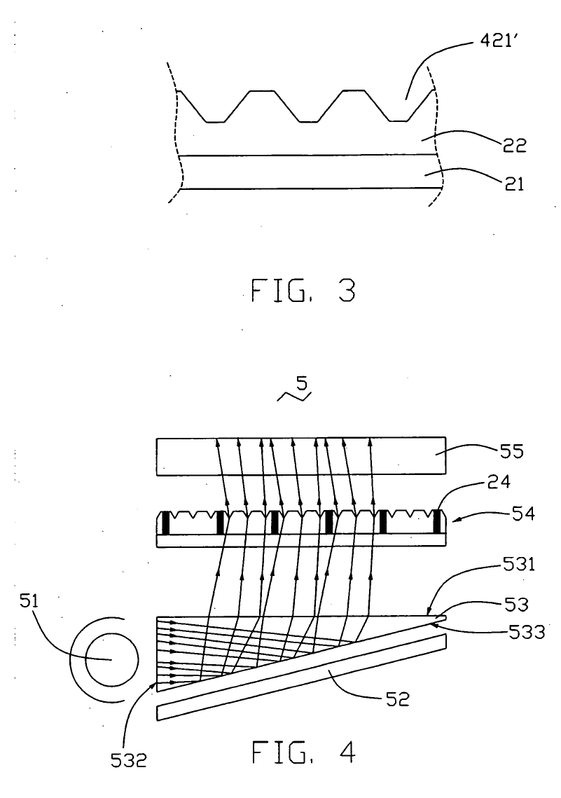

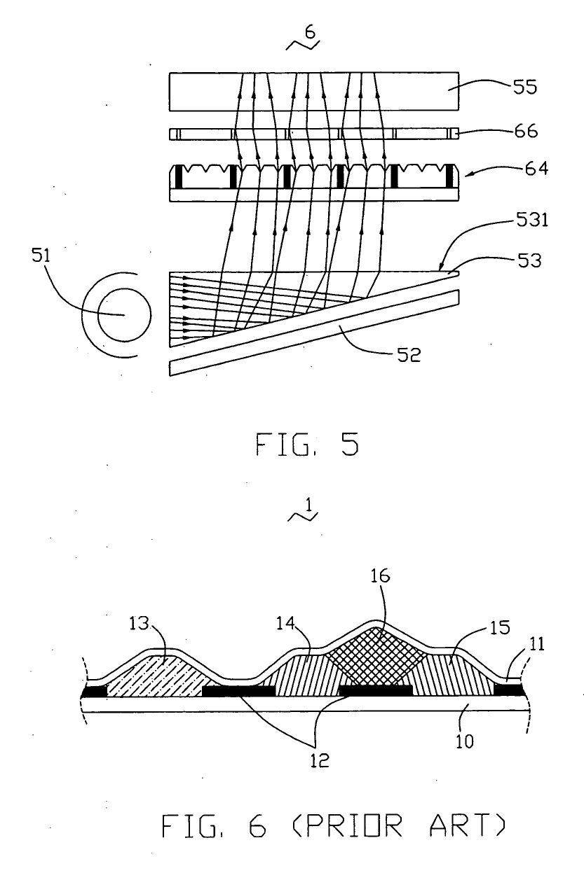

The grating layer 22 is used to provide the light of a given color for example, R(ed)-light, G(reen)-light, and B(lue)-light. An energy distribution of the R-light, the G-light, and the B-light is determined by the configuration of the striated microstructure of the grating. The striated microstructure can be of any suitable structure such as grooves or protrusions. For instance, as shown in FIG. 2, a striated microstructure 321′ has an arcuate surface 2211′. As shown in FIG. 3, the cross-section of the striated microstructure 421′ is a trapezoid. The cross-section of the striated microstructure can be rectangular or triangle-shaped etc.

Because the piezoelectric material deforms under a voltage differential, the controlling unit can control the grating constant of the striated microstructure 221′ connected therewith through applying the voltage differential to the striated microstructure 221′. The relationship between the grating constant and the light wavelength obeys the following equation: d(sin θ−sin θ1)=mλ, where d is the grating constant, θ is angle of emergence, θ1 is angle of incidence, λ is optical wavelength, and m is an integer, the grating constant d is independently variable and the angle of emergence θ is dependently variable when the angle of incidence θ1 of white light is known. In the illustrated embodiment, the striated microstructures 221′ can cooperatively separate the incident white light into, for example, the R-light, the G-light, or the B-light and control angle of emergence of the light separated by adjusting of the grating constant of the grating unit 221.

The grating units 221 are configured to spatially correspond to the sub-pixel of the liquid crystal display panel. For example, every three adjacent grating units 221 are configured to correspond to one pixel that consists of R sub-pixels G sub-pixels and B sub-pixels of the liquid crystal display panel. The R-light, the G-light, and the B-light separated by the grating units 221 is directed to the corresponding sub-pixels.

FIG. 4 shows a schematic view of a liquid crystal display in accordance with a second embodiment. The liquid crystal display 5 includes a light source 51, a wedge-shaped light guide plate 53, a color filter 54, and a liquid crystal display panel 55. The wedge-shaped light guide plate 53 includes a light incidence surface 532, a light-emitting surface 531 connecting with the light incidence surface 532, and a bottom surface 533 opposite to the light-emitting surface 531. The light source 51 faces the light incidence surface 532. The liquid crystal display 5 further includes a reflector plate 52 facing the bottom surface 533. The wedge-shaped light guide plate 53 can provide a uniform surface light source. The color filter 54 of the second embodiment is similar to the color filter 2 of the first embodiment.

In this embodiment, each sub-pixel of the liquid crystal display panel 55 corresponds to a grating unit of the color filter 54. Each pixel consists of an R sub-pixel a G sub-pixel and a B sub-pixel. In other words, every three adjacent grating units correspond to a common pixel.

FIG. 5 shows a schematic view of a liquid crystal display in accordance with a third embodiment. The liquid crystal display 6 is similar to that of the second embodiment, except that a collective lens 66 is positioned between the color filter 64 and the liquid crystal display panel 55. The R-light, the G-light, and the B-light can be converged onto a respective pixel of the liquid crystal display panel 55.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A color filter comprising:
a base;
a black matrix arranged on the base; and
a grating layer arranged on the base, the grating layer comprising a plurality of grating units separated by the black matrix, the grating units being comprised of a piezoelectric material, the grating unit comprising a plurality of striated microstructures; and a controlling circuit comprising a plurality of controlling units electrically connected with the respective striated microstructures, the controlling units each being configured to apply a voltage to their corresponding striated microstructures so as to adjust a grating constant associated therewith, thereby allowing light with a predetermined wavelength to be filtered through the grating unit.

2. The color filter as claimed in claim 1, wherein the grating unit is a phase grating.

3. The color filter as claimed in claim 1, wherein the striated microstructure is a groove.

4. The color filter as claimed in claim 1, wherein a surface of the striated microstructure is an arcuate surface.

5. The color filter as claimed in claim 1, wherein a cross-section of the striated microstructure is rectanglar, trapezoid or triangle-shaped.

6. A liquid crystal display, comprising:
a liquid crystal display panel;
a backlight module;
a color filter disposed between the liquid crystal display panel and the backlight module, the color filter comprising
a base;
a black matrix arranged on the base;
a grating layer arranged on the base, the grating layer comprising a plurality of grating units separated by the black matrix, the grating units being comprised of a piezoelectric material, each grating unit comprising a plurality of striated microstructures; and a controlling circuit comprising a plurality of controlling units electrically connected with the respective striated microstructures, the controlling units each being configured to apply a voltage to their corresponding striated microstructures so as to adjust a grating constant associated therewith, thereby allowing light with a predetermined wavelength to be filtered through the grating unit.

7. The liquid crystal display as claimed in claim 6, wherein the grating unit is a phase grating.

8. The liquid crystal display as claimed in claim 6, wherein the striated microstructure is a groove.

9. The liquid crystal display as claimed in claim 6, wherein a surface of the striated microstructure is an arcuate surface.

10. The liquid crystal display as claimed in claim 6, wherein a cross-section of the striated microstructure is rectangular, trapezoid or triangle-shaped.

11. The liquid crystal display as claimed in claim 6, wherein the liquid crystal display further comprising a collective lens, the collective lens is positioned between the color filter and the liquid crystal display panel.
